(19) United States
(12) Patent Application Publication
(10) Pub. No.: US 2026/0356036 A1
(43) Pub. Date: Nov. 12, 2026

(54) HIGH-FLOW COMPACT 3D PRINT HEAD

(71) Applicant: Shanghai Fusion Tech Co., Ltd., Shanghai (CN)

(72) Inventors: Jianzhe Li, Shanghai (CN); Yang Song, Shanghai (CN)

(73) Assignee: Shanghai Fusion Tech Co., Ltd., Shanghai (CN)

(21) Appl. No.: 19/203,859

(22) Filed: May 9, 2025

(51) Int. Cl. B29C 64/209; B29C 48/02; B29C 48/285; B29C 64/336; B33Y 30/00; B33Y 40/00

(52) U.S. Cl. CPC B29C 64/209; B29C 48/02; B29C 48/288; B29C 64/336; B33Y 30/00; B33Y 40/00

(57) ABSTRACT

Systems for printing 3D objects from polymer filaments is provided. In some examples, the systems comprise a multi-channel extruder mechanism that can simultaneously control the supply of two or more materials. The materials may be the same composition or may be different compositions. The materials may be the same color or may be different colors. If printing a single composition or color, all of the channels may be employed for high speed 3D printing. If printing multiple compositions or colors, a single channel may be active while the other channels remain inactive. The melted materials are supplied to a single nozzle used to print the 3D product. These features result in a system that is flexible, small, lightweight, lower cost, exhibits low defect rates, and has high printing speed.

### FIELD OF THE DISCLOSURE

The disclosure relates generally to the field of additive manufacturing. More specifically, the disclosure relates to systems and methods for 3-dimensional (3D) printing using a high-flow compact print head.

### BACKGROUND

Traditional fused deposition technology employed for 3D printing may use a roll of cylindrical filaments or granular materials with small diameters (e.g. between about 1.75 mm and about 2.85 mm) as raw materials for printing. Print heads used in this technology are typically small, weighing between about 0.5 Kg and about 1.0 Kg. The small size and heating capacity limits the throughput of the 3D printing system. For example, a 3D printing system having a heating area length of between about 30 mm and about 40 mm and utilizing a nozzle diameter of about 0.4 mm will have a melting capacity of between about 25 mm³/sec and about 35 mm³/sec. This results in a printing capacity of between about 100 g/hr and about 150 g/hr. It is advantageous to increase the 3D printing speed. However, this heating capacity imposes an upper limit on the 3D printing speed. Typical solutions to increasing the 3D printing speed involve the use of larger heating areas. However, if the heating area is increased by about 1-2 times, this results in a melting capacity increase of only between about 30% and about 40%. This greatly increases the weight of the print head and the larger heating area typically leads to a reduction in 3D print quality. Thus far, it has not been possible to achieve a multiple improvement in 3D print speed without a degradation in the printed product.

Alternatively, screw extruder systems have been used with plastic particle materials in 3D printing as an alternative to the filament based systems described above. These systems have larger melting capacities, typically between about 200 mm³/sec and about 300 mm³/sec, equivalent to about 0.6 Kg/hr and about 1.0 Kg/hr. However, the weight of these systems is heavy and may be between about 5 Kg and about 20 Kg. The heavy weight of these systems greatly reduces the speed of the print head and also greatly increases the cost of the system. Finally, 3D printing from particle material based systems is more complicated and less convenient than 3D printing from filament based systems.

3D printed products may require printing in multiple compositions and/or colors. This is difficult to accomplish efficiently using the present systems discussed above. In a first case, the filament or particle material supply for a first composition and/or color is stopped at the end of the first printing step. The remaining printing material is extracted from the extruder and a second composition and/or color filament or supply of particle material is introduced and the printing of the second composition and/or color is continued. In a second case, multiple print heads are employed, each with the ability to print a specific composition and/or color. These print heads comprise the extruder devices and heat areas as discussed above. The print heads are placed tightly together and require careful positioning and alignment when switching active printing from the first print head to the second print head. However, this configuration adds size, weight, expense, and complexity to the system. Small errors in the positioning or alignment may lead to defects in the 3D printed product.

Therefore, it would be desirable to have a system with high 3D print speed while maintaining acceptable printed product quality. Further, it would be desirable to have a system with high 3D print speed capable of printing in multiple compositions and/or colors while maintaining acceptable printed product quality.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, systems for printing 3D objects from polymer filaments are provided. In some embodiments, the systems comprise a multi-channel extruder mechanism that may simultaneously control the supply of two or more materials. The materials may be the same composition or may be different compositions. The materials may be the same color or may be different colors. If printing a single composition and/or color, all of the two or more channels may be employed for high speed 3D printing. If printing multiple compositions and/or colors, a single channel may be active while the other channels remain inactive. The melted materials are supplied to a single nozzle used to print the 3D product. The use of a single nozzle improves the accuracy, precision, and quality of the resulting product. These features result in systems that are flexible, small, lightweight, lower cost, exhibit low defect rates, and have high printing speed.

### BRIEF DESCRIPTION OF THE DRAWINGS

Illustrative embodiments of the present disclosure are described in detail below with reference to the attached drawing figures.

FIGS. 1A and 1B are schematics of exemplary systems according to some embodiments of the disclosure.

FIGS. 2A and 2B are schematics of exemplary systems according to some embodiments of the disclosure.

FIG. 3 is a schematic of exemplary systems according to some embodiments of the disclosure.

FIG. 4 is a schematic of exemplary systems according to some embodiments of the disclosure.

FIGS. 5A and 5B are schematics of exemplary systems according to some embodiments of the disclosure.

FIG. 6 is a schematic of exemplary systems according to some embodiments of the disclosure.

### DETAILED DESCRIPTION

The following describes some non-limiting exemplary embodiments of the invention with reference to the accompanying drawings. The described embodiments are merely a part rather than all of the embodiments of the invention. All other embodiments obtained by a person of ordinary skill in the art based on the embodiments of the disclosure shall fall within the scope of the disclosure.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology may include a variety of combinations and/or integrations of the embodiments described herein.

It must be noted that as used herein and, in the claims, the singular forms “a,” “an” and “the” include plural referents unless the context clearly dictates otherwise. Thus, for example, reference to “a layer” includes two or more layers, and so forth.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention. Where the modifier “about” or “approximately” is used, the stated quantity may vary by up to 10%.

The term “horizontal” as used herein will be understood to be defined as a plane parallel to the plane or surface of the substrate, regardless of the orientation of the substrate. The term “vertical” will refer to a direction perpendicular to the horizontal as previously defined. Terms such as “above”, “below”, “bottom”, “top”, “side” (e.g. sidewall), “higher”, “lower”, “upper”, “over”, and “under”, are defined with respect to the horizontal plane. The term “on” means there is direct contact between the elements. The term “above” will allow for intervening elements.

As used herein, the terms “first,” “second,” and other ordinals will be understood to provide differentiation only, rather than imposing any specific spatial or temporal order.

As used herein, the term “substantially” generally refers to ±5% of a stated value.

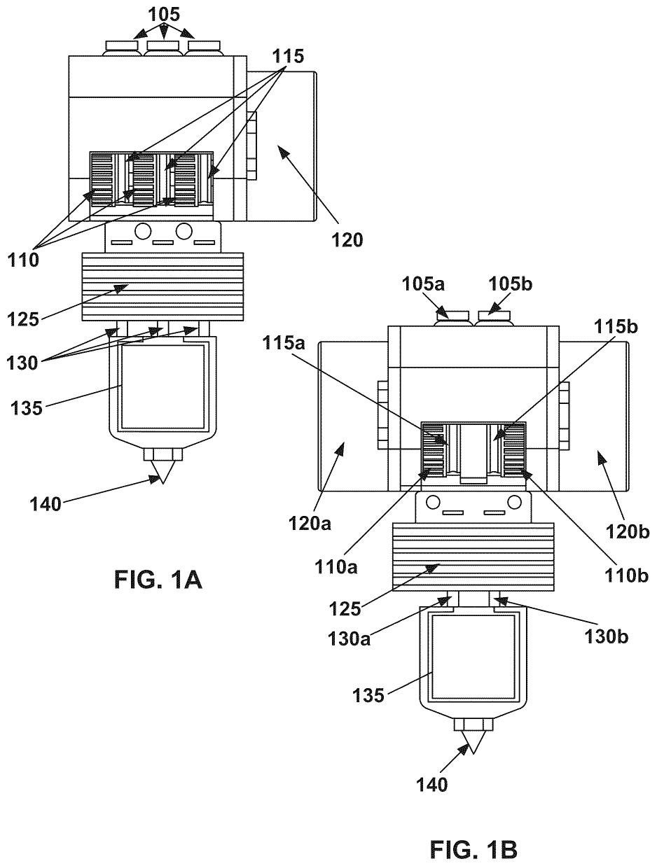

This disclosure provides systems and methods for manufacturing an object using 3D printers. FIGS. 1A-1B are schematics of exemplary systems according to some embodiments of the disclosure. The systems include a print head comprising a multi-channel extruder structure and melting device.

In FIG. 1A, the multi-channel extruder structure comprises two or more filament input guides, 105. Three filament input guides are illustrated in FIG. 1A. The extruder structure further comprises two or more driver mechanisms 110 used to move the filaments through channels 115. Generally, there is a driver mechanism 110 and a channel 115 associated with each filament input guide 105. The driver mechanisms 110 are activated by a motor 120. Motor 120 may be one of an electromagnetic motor, a piezoelectric displacement device, a memory alloy displacement device, a stepper motor, a servo motor, a brushless DC motor, or a carbon brush motor. Motor 120 is operable to move driver mechanism 110 in a first direction wherein the filaments will be moved in a downward direction in the schematic. Motor 120 is also operable to move driver mechanism 110 in a second direction wherein the filaments will be moved in an upward direction in the schematic. Motor 120 is managed by a controller (not shown). The controller determines the speed and the direction of operation of motor 120. The controller may be one of a mechanical controller, an electronic controller, or a software driven controller.

In FIG. 1A the melting device comprises cold end 125 coupled to two or more input ducts 130. Three input ducts are illustrated in FIG. 1A. Generally, there is an input duct 130 associated with each filament input guide 105 and channel 115. Input ducts 130 feed into a melting device 135 where the filaments are melted. The melted filaments are delivered to nozzle 140 for printing the 3D product. The temperature set point of melting device 135 is established and monitored by the same controller as discussed above.

FIG. 1A illustrates a print head that is useful for high speed printing. The single motor 120 is operable to simultaneously deliver two or more filaments to the melting device. As an example, the three filament configuration illustrated in FIG. 1A may provide up to three times the throughput of conventional print heads. The high volume of melted material being supplied to a single nozzle results in a high quality 3D printed product with reduced defects.

In FIG. 1B, the multi-channel extruder structure comprises two or more filament input guides, 105a and 105b. Two filament input guides are illustrated in FIG. 1B. The filaments may have different compositions and/or different colors. The extruder structure further comprises two or more driver mechanisms 110a and 110b used to move the filaments through channels 115a and 115b. Generally, there is a driver mechanism and a channel associated with each filament input guide. The driver mechanisms are activated by motors 120a and 120b. Motor 120a and 120b may be one of an electromagnetic motor, a piezoelectric displacement device, a memory alloy displacement device, a stepper motor, a servo motor, a brushless DC motor, or a carbon brush motor. Motor 120a is operable to move driver mechanism 110a in a first direction wherein the filaments will be moved in a downward direction in the schematic. Motor 120a is also operable to move driver mechanism 110a in a second direction wherein the filaments will be moved in an upward direction in the schematic. Motor 120b is operable to move driver mechanism 110b in a first direction wherein the filaments will be moved in a downward direction in the schematic. Motor 120b is also operable to move driver mechanism 110b in a second direction wherein the filaments will be moved in an upward direction in the schematic. Motors 120a and 120b are managed by a controller (not shown). The controller determines the speed and the direction of operation of motors 120a and 120b. The controller may be one of a mechanical controller, an electronic controller, or a software driven controller. The operations of motors 120a and 120b are independent from one another. As an example, one motor may be activated while the other motor is inactive. In this way, a specific filament having a desired composition and/or color may be selected for printing and then the print head may switch to the other filament by stopping the associated motor and activating the other motor.

In FIG. 1B the melting device comprises cold end 125 coupled to two or more input ducts 130a and 130b. Two input ducts are illustrated in FIG. 1B. Generally, there is an input duct associated with each filament input guide and channel. Input ducts 130a and 130b feed into a melting device 135 where the filaments are melted. The melted filaments are delivered to nozzle 140 for printing the 3D product. The temperature set point of melting device 135 is established and monitored by the same controller as discussed above.

FIG. 1B illustrates a print head that is useful for high speed printing with filaments that may be of different compositions and/or different colors. Each motor 120a or 120b is operable to deliver the associated filament to the melting device. The melted material of different compositions and/or colors being supplied to a single nozzle results in a high quality 3D printed product with reduced defects since there is no realignment required when switching between the various filament types. The configuration illustrated in FIG. 1B may also provide up to two times the throughput of conventional print heads when filaments of the same composition and/or color are used.

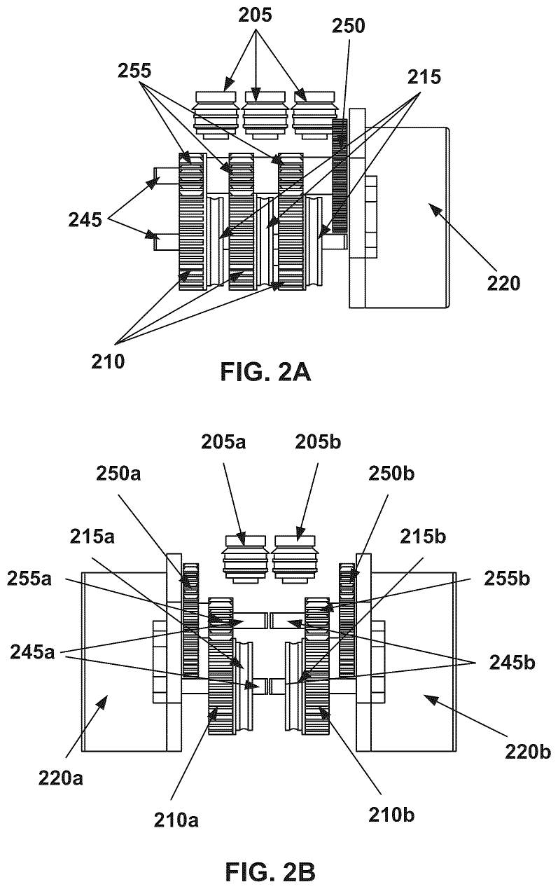

FIGS. 2A-2B are more detailed schematics of exemplary multi-channel extruder structures according to some embodiments of the disclosure. In FIG. 2A, the extruder structure comprises two or more filament input guides, 205. Three filament input guides are illustrated in FIG. 2A. The extruder structure further comprises two or more driver mechanisms 210 used to move the filaments through channels 215. Generally, there is a driver mechanism 210 and a channel 215 associated with each filament input guide 205. The driver mechanisms 210 are activated by a motor 220. Motor 220 may be one of an electromagnetic motor, a piezoelectric displacement device, a memory alloy displacement device, a stepper motor, a servo motor, a brushless DC motor, or a carbon brush motor. Motor 220 connects to driver mechanisms 210 through transmission shafts 245, gear 250, and gears 255. This configuration of shafts and gears forms a conventional reduction gear as is known in the art. Motor 220 is operable to move driver mechanism 210 in a first direction wherein the filaments will be moved in a downward direction in the schematic. Motor 220 is also operable to move driver mechanism 210 in a second direction wherein the filaments will be moved in an upward direction in the schematic. Motor 220 is managed by a controller (not shown). The controller determines the speed and the direction of operation of motor 220. The controller may be one of a mechanical controller, an electronic controller, or a software driven controller.

In FIG. 2B, the multi-channel extruder structure comprises two or more filament input guides, 205a and 205b. Two filament input guides are illustrated in FIG. 2B. The extruder structure further comprises two or more driver mechanisms 210a and 210b used to move the filaments through channels 215a and 215b. Generally, there is a driver mechanism and a channel associated with each filament input guide. The driver mechanisms 210a and 210b are activated by a motors 220a and 220b. Motors 220a and 220b may be one of an electromagnetic motor, a piezoelectric displacement device, a memory alloy displacement device, a stepper motor, a servo motor, a brushless DC motor, or a carbon brush motor. Motors 220a and 220b connect to driver mechanisms 210a and 210b through transmission shafts 245a and 245b, gears 250a and 250b, and gears 255a and 255b respectively. This configuration of shafts and gears forms a conventional reduction gear as is known in the art. Motor 220a is operable to move driver mechanism 210a in a first direction wherein the filaments will be moved in a downward direction in the schematic. Motor 220a is also operable to move driver mechanism 210a in a second direction wherein the filaments will be moved in an upward direction in the schematic. Motor 220b is operable to move driver mechanism 210b in a first direction wherein the filaments will be moved in a downward direction in the schematic. Motor 220b is also operable to move driver mechanism 210b in a second direction wherein the filaments will be moved in an upward direction in the schematic. Motors 220a and 220b are managed by a controller (not shown). The controller determines the speed and the direction of operation of motors 220a and 220b. The controller may be one of a mechanical controller, an electronic controller, or a software driven controller. The operations of motors 220a and 220b are independent from one another. As an example, one motor may be activated while the other motor is inactive. In this way, a specific filament having a desired composition and/or color may be selected for printing and then the print head may switch to the other filament by stopping the associated motor and activating the other motor.

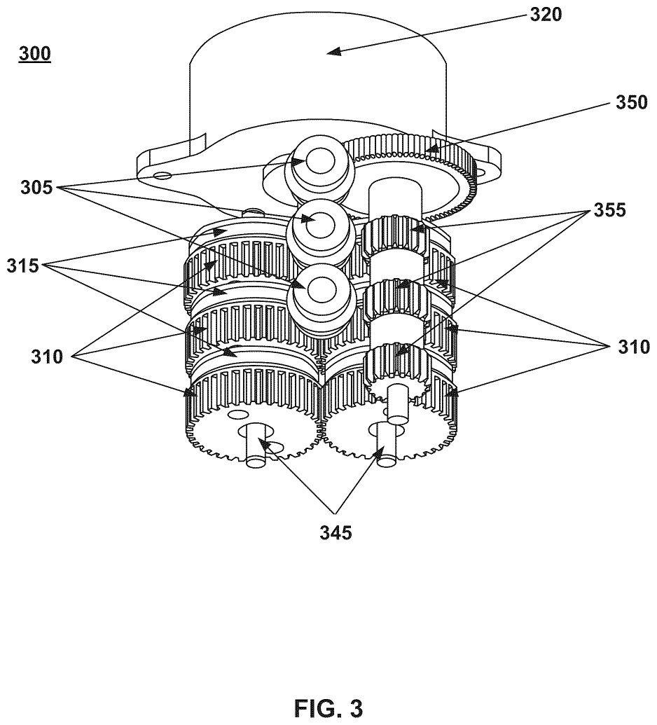

FIG. 3 is a more detailed schematic of exemplary multi-channel extruder structures according to some embodiments of the disclosure. In FIG. 3, the extruder structure comprises two or more filament input guides, 305. Three filament input guides are illustrated in FIG. 3. The extruder structure further comprises two or more driver mechanisms 310 used to move the filaments through channels 315. Generally, there is a driver mechanism 310 and a channel 315 associated with each filament input guide 305. As illustrated in FIG. 3, driver mechanisms 310 are comprised of pairs of gears. The channels 315 may use a friction mechanism or a bite mechanism to capture the filament. The driver mechanisms 310 are activated by a motor 320. Motor 320 may be one of an electromagnetic motor, a piezoelectric displacement device, a memory alloy displacement device, a stepper motor, a servo motor, a brushless DC motor, or a carbon brush motor. Motor 320 connects to driver mechanisms 310 through transmission shafts 345, gear 350, and gears 355. This configuration of shafts and gears forms a conventional reduction gear as is known in the art. Motor 320 is operable to move driver mechanism 310 in a first direction wherein the filaments will be moved in a direction into the page in the schematic. Motor 320 is also operable to move driver mechanism 310 in a second direction wherein the filaments will be moved in a direction out of the page in the schematic. Motor 320 is managed by a controller (not shown). The controller determines the speed and the direction of operation of motor 320. The controller may be one of a mechanical controller, an electronic controller, or a software driven controller.

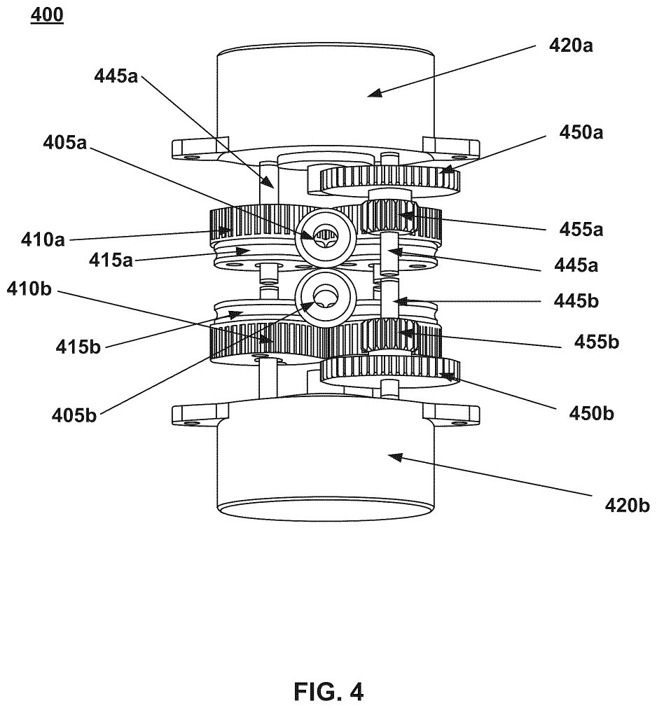

FIG. 4 is a more detailed schematic of exemplary multi-channel extruder structures according to some embodiments of the disclosure. In FIG. 4, the extruder structure comprises two or more filament input guides, 405a and 405b. Two filament input guides are illustrated in FIG. 4. The extruder structure further comprises two or more driver mechanisms 410a and 410b used to move the filaments through channels 415a and 415b. Generally, there is a driver mechanism and a channel associated with each filament input guide. As illustrated in FIG. 4, driver mechanisms 410a and 410b are comprised of pairs of gears. The channels 415a and 415b may use a friction mechanism or a bite mechanism to capture the filament. The driver mechanisms 410a and 410b are activated by a motors 420a and 420b. Motors 420a and 420b may be one of an electromagnetic motor, a piezoelectric displacement device, a memory alloy displacement device, a stepper motor, a servo motor, a brushless DC motor, or a carbon brush motor. Motors 420a and 420b connect to driver mechanisms 410a and 410b through transmission shafts 445a and 445b, gears 450a and 450b, and gears 455a and 455b respectively. This configuration of shafts and gears forms a conventional reduction gear as is known in the art. Motor 420a is operable to move driver mechanism 410a in a first direction wherein the filaments will be moved in a direction into the page in the schematic. Motor 420a is also operable to move driver mechanism 410a in a second direction wherein the filaments will be moved in a direction out of the page in the schematic. Motor 420b is operable to move driver mechanism 410b in a first direction wherein the filaments will be moved in a direction into the page in the schematic. Motor 420b is also operable to move driver mechanism 410b in a second direction wherein the filaments will be moved in a direction out of the page in the schematic. Motors 420a and 420b are managed by a controller (not shown). The controller determines the speed and the direction of operation of motors 420a and 420b. The controller may be one of a mechanical controller, an electronic controller, or a software driven controller. The operations of motors 420a and 420b are independent from one another. As an example, one motor may be activated while the other motor is inactive. In this way, a specific filament having a desired composition and/or color may be selected for printing and then the print head may switch to the other filament by stopping the associated motor and activating the other motor.

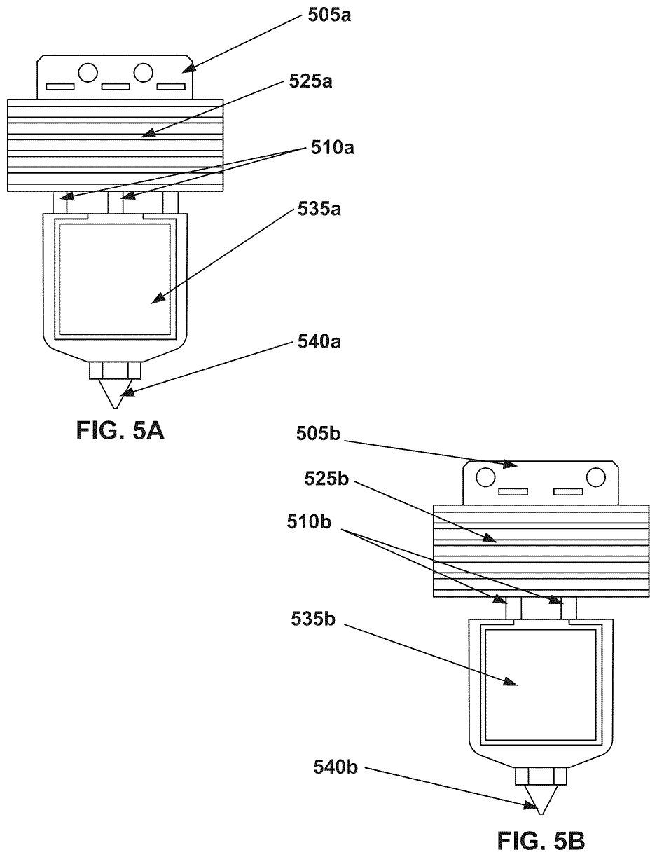

FIGS. 5A and 5B are schematics of exemplary systems according to some embodiments of the disclosure. FIGS. 5A and 5B are schematics of exemplary melting devices. In FIG. 5A, element 505a represents the interface between the multi-channel extruder structures and the melting devices described above. Filaments from the extruder structures pass through the cold end 525a and through input ducts 510a. There are at least two input ducts 510a. In FIG. 5A, three input ducts are illustrated. Input ducts 530a feed into a melting device 535 where the filaments are melted. The melted filaments are delivered to nozzle 540 for printing the 3D product. The temperature set point of melting device 535 is established and monitored by the controller as discussed above. The configuration illustrated in FIG. 5A would be compatible with the extruder structure discussed with respect to FIG. 3.

In FIG. 5B, element 505b represents the interface between the multi-channel extruder structures and the melting devices described above. Filaments from the extruder structures pass through the cold end 525b and through input ducts 510b. There are at least two input ducts 510b. In FIG. 5B, two input ducts are illustrated. Input ducts 530b feed into a melting device 535 where the filaments are melted. The melted filaments are delivered to nozzle 540 for printing the 3D product. The temperature set point of melting device 535 is established and monitored by the controller as discussed above. The configuration illustrated in FIG. 5B would be compatible with the extruder structure discussed with respect to FIG. 4.

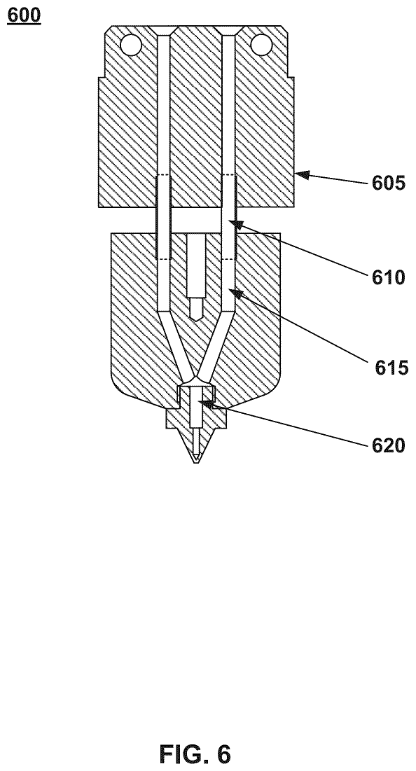

FIG. 6 is a schematic of an exemplary system according to some embodiments of the disclosure. FIG. 6 illustrates the details of the melting device 135 as described in FIGS. 1A and 1B and elsewhere. This description is for a single channel of the systems described above and will be the same for each channel implemented. The filament exits the extruder structure described previously and enters the cold end 605 of the melting device (element 125 in FIGS. 1A and 1B). The filament passes from the cold end 605 into the input duct 610 (element 130 in FIGS. 1A and 1B). The input duct 610 acts to separate the cold end from the hot end of the melting device. The filament then enters the hot end 615 of the melting device and is melted. Finally, the melted material is extruded through the nozzle 620 (element 140 in FIGS. 1A and 1B) to form the 3D printed product.

The benefits of the print head configurations discussed above may be illustrated by the following examples. A system as described in FIG. 1A and having three input channels may weigh about 800 g. A common filament used for 3D printing is polylactic acid (PLA) filament. Using PLA filaments having a diameter of 1.75 mm in all three filament input guides and an output nozzle diameter of 0.4 mm provides a plastic melting capacity of between about 80 mm³/sec and about 115 mm³/sec, equivalent to between about 300 g/hr and about 500 g/hr. This is about three times the melting capacity of the systems described in the Background section of this disclosure without the large increase in weight and complexity.

A system as described in FIG. 1A and having six input channels may weigh about 1200 g. Using PLA filaments having a diameter of 1.75 mm in all six filament input guides and an output nozzle diameter of 0.4 mm provides a plastic melting capacity of between about 160 mm³/sec and about 240 mm³/sec, equivalent to between about 600 g/hr and about 1000 g/hr. This is about six times the melting capacity of the systems described in the Background section of this disclosure without the large increase in weight and complexity.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A system for manufacturing three-dimensional objects, the system comprising:
a print head comprising a multi-channel extrusion structure, wherein the multi-channel extrusion structure comprises three driver mechanisms operable to move three filaments into the print head and a channel associated with each driver mechanism operable to guide the three filaments;
a motor operable to activate the driver mechanisms;
a controller for controlling a speed and a direction of the driver mechanisms;
a melting device operable to melt the three filaments; and
a nozzle operable to output the melted filaments.

2. The system in claim 1, wherein the controller further controls a temperature set point of the melting device.

3. The system in claim 1, wherein the controller is one of a mechanical controller, an electronic controller, or a software driven controller.

4. The system in claim 1, wherein the three filaments are moved into the print head at a same time.

5. The system in claim 1, wherein the motor comprises one of an electromagnetic motor, a piezoelectric displacement device, a memory alloy displacement device, a stepper motor, a servo motor, a brushless DC motor, or a carbon brush motor.

6. The system in claim 1, wherein each of the three filaments is a same color.

7. The system in claim 1, wherein each of the three filaments is of a same composition.

8. The system in claim 1, wherein driving mechanisms capture the three filaments through one of a friction interface or a bite interface.

9. The system in claim 1, wherein the motor is connected to the driver mechanisms through transmission shafts and gears.

10. The system in claim 1, wherein the motor activates all of the three driver mechanisms.
